(19) United States
(12) Patent Application Publication
(10) Pub. No.: US 2025/0007786 A1
(43) Pub. Date: Jan. 2, 2025

(54) DATA DISTRIBUTION SYSTEM, COMMUNICATION QUALITY PREDICTION APPARATUS, DATA TRANSMISSION APPARATUS AND DATA TRANSMISSION METHOD

(71) Applicant: NEC Corporation, Minato-ku, Tokyo (JP)

(72) Inventor: Koichi NIHEI, Tokyo (JP)

(73) Assignee: NEC Corporation, Minato-ku, Tokyo (JP)

(21) Appl. No.: 18/291,985

(22) PCT Filed: Jul. 29, 2021
(86) PCT No.: PCT/JP2021/028055

§ 371 Date: Jan. 25, 2024

(51) Int. Cl. H04L 41/147; H04W 72/542

(52) U.S. Cl. CPC H04L 41/147; H04W 72/542

(57) ABSTRACT

A data distribution system includes a first prediction part for predicting communication quality of a network used for transmission of first sensor data based on the first sensor data; a determination part for determining a parameter related to transmission quality of the first sensor data according to the communication quality predicted by the first prediction part; an encoding part for encoding the first sensor data using the parameter related to the transmission quality of the first sensor data; and a transmission part for transmitting the encoded first sensor data via the network.

### TECHNICAL FIELD

The present invention relates to a data distribution system, a communication quality prediction apparatus, a data transmission apparatus, and a data transmission method.

### BACKGROUND ART

Data shot by a camera mounted on a movable body, such as an autonomous driving car, an unmanned aerial vehicle, and so on or a wearable camera worn by a worker is being live-distributed to a remote control center or the like and is being used for a monitoring operation. It is known that transmission of shot data shot by these cameras is affected by transmission quality of the network due to passing through a wireless section.

Patent Literature (PTL) 1 discloses a communication quality adjustment system which has an environmental information acquisition part which acquires environmental information indicating environment at which a receiver is placed and affecting a communication state of the receiver and enables to cause the receiver to receive video contents with a stable quality.

PLT 2 discloses, in an unmanned autonomous driving system, drone control or robot control in which apparatuses are remotely managed, a configuration that terminals mounted on these apparatuses predict communication quality between this terminal and an external communication apparatus. Then, these terminals perform terminal control in such a way as to improve communication quality, avoid deadly communication quality degradation or satisfy a control condition of communication quality for the terminal based on a predicted communication quality.

PTL 3 discloses a traffic control apparatus which can perform a traffic control by deep reinforcement learning using a camera image as an input and make efficient use of a radio band by automatically adapting various communication environments.

### CITATION LIST

### Patent Literature

PTL 1: WO2019/059134A1
PTL 2: WO2020/217460A1
PTL 3 Japanese Patent Kokai Publication No: 2019-208188

### SUMMARY

### Technical Problem

The following analysis has been made by the present inventor. The transmission apparatus of sensor data such as shot data and so on as described above moves along with a movable body or a worker. As a result of the movement, a sudden fluctuation in communication throughput may be caused due to interposition of a shield between the transmission apparatus and a base station. At this point, PTL 1 changes a communication state of a receiver and a reception mode for receiving contents by the receiver based on environment information such as a position and a velocity or the like of the receiver when the receiver is a mobile station and cannot cope with a sudden fluctuation in communication throughput due to movement of a transmission apparatus.

Furthermore, a terminal in PTL 2 has a configuration to avoid a sudden fluctuation in communication throughput by predicting future communication quality using surrounding environment information of the terminal and controlling own apparatus according to the future communication quality. As a result, for example, it is not possible to avoid a sudden fluctuation in communication throughput if it is not possible to restrict a velocity less than or equal to 5 km/h and to stop at a road shoulder which are control rules in a case where communication quality is the worst in FIG. 4 of PTL 2.

PTL 3 only discloses a configuration for increasing total throughput by shooting communication environments between a first communication apparatus and one or more second communication apparatus using a camera and predicting communication quality for each wireless section.

It is an object of the present invention to provide a data distribution system, a communication quality prediction apparatus, a data transmission apparatus, and a data transmission method which can cope with a sudden fluctuation in communication throughput due to movement of a transmission apparatus of sensor data.

### Solution to Problem

According to a first aspect, there is provided a data distribution system, including: first prediction means for predicting communication quality of a network used for transmission of first sensor data based on the first sensor data; determination means for determining a parameter related to transmission quality of the first sensor data according to the communication quality predicted by the first prediction means; encoding means for encoding the first sensor data using the parameter related to the transmission quality of the first sensor data; and transmission means for transmitting the encoded first sensor data via the network.

According to a second aspect, there is provided a communication quality prediction apparatus, including: first prediction means for predicting communication quality of a network used for transmission of first sensor data based on the first sensor data; and transmission means for transmitting the predicted communication quality of the network used for transmission of the first sensor data to an apparatus of a transmission source of the first sensor data. The communication quality prediction apparatus causes the apparatus of the transmission source of the first sensor data to execute to encode the first sensor data according to the predicted communication quality of the network used for transmission of the first sensor data and to transmit the encoded first sensor data.

According to a third aspect, there is provided a data transmission apparatus, which can execute to recieve predicted communication quality of a network used for transmission of first sensor data from a communication quality prediction apparatus including: first prediction means for predicting the communication quality of the network used for transmission of first sensor data based on the first sensor data; and transmission means for transmitting the predicted communication quality of the network used for transmission of the first sensor data to an apparatus of a transmission source of the first sensor data; and wherein the data transmission apparatus can execute to: encode the first sensor data according to the communication quality, and transmit the encoded first sensor data.

According to a fourth aspect, there is provided a data transmission method, including: predicting communication quality of a network used for transmission of first sensor data based on the first sensor data; determining a parameter related to transmission quality of the first sensor data according to the predicted communication quality; encoding the first sensor data using the parameter related to the transmission quality of the first sensor data; and transmitting the encoded first sensor data via the network. This method is associated with a certain machine, which is a computer which predicts communication quality of a network used for transmission of a sensor data based on the sensor data.

According to a fifth aspect, there is provided a program (a computer program) for realizing the functions of apparatuses making up the above data distribution system. This computer program is inputted to a computer apparatus via an input device or a communication interface from outside, is stored in a storage device, and drives a processor in accordance with predetermined steps or processing. In addition, this program can display, as needed, a processing result including an intermediate state per stage on a display device or can communicate with outside via the communication interface. As an example, the computer apparatus for this purpose typically includes a processor, a storage device, an input device, a communication interface, and as needed, a display device, which can be connected to each other via a bus. In addition, this program can be recorded in a computer-readable (non-transitory) storage medium.

### Advantageous Effects of Invention

According to the present invention, it is possible to provide a data distribution system, a communication quality prediction apparatus, a data transmission apparatus, and a data transmission method which can cope with a sudden fluctuation in communication throughput due to movement of a transmission apparatus of sensor data.

### BRIEF DESCRIPTION OF DRAWINGS

FIG. 1 is a diagram illustrating a configuration according to an example embodiment of the present invention.

FIG. 2 is a flow chart illustrating an operation of a data distribution system according to the example embodiment of the present invention.

FIG. 3 is a diagram illustrating an example of a configuration of a data distribution system according to the example embodiment of the present invention.

FIG. 4 is a diagram illustrating another example of a configuration of a data distribution system according to the example embodiment of the present invention.

FIG. 5 is a diagram illustrating a different example of a configuration of a data distribution system according to the example embodiment of the present invention.

FIG. 6 is a diagram illustrating a configuration of a shot data distribution system according to a first example embodiment of the present invention.

FIG. 7 is a sequence diagram illustrating an operation of the shot data distribution system according to the first example embodiment of the present invention.

FIG. 8 is a diagram illustrating a concrete operation of the shot data distribution system according to the first example embodiment of the present invention.

FIG. 9 is a diagram illustrating a concrete operation of the shot data distribution system according to the first example embodiment of the present invention.

FIG. 10 is a diagram illustrating a configuration of a shot data distribution system according to a second example embodiment of the present invention.

FIG. 11 is a diagram illustrating a configuration of a communication quality prediction apparatus according to the second example embodiment of the present invention.

FIG. 12 is a diagram illustrating another example of a unification processing of a unification part of a communication quality prediction apparatus according to the second example embodiment of the present invention.

FIG. 13 is a diagram illustrating a different example of a unification processing of a unification part of a communication quality prediction apparatus according to the second example embodiment of the present invention.

FIG. 14 is a diagram illustrating another different example of a unification processing of a unification part of a communication quality prediction apparatus according to the second example embodiment of the present invention.

FIG. 15 is a diagram illustrating a further different example of a unification processing of a unification part of a communication quality prediction apparatus according to the second example embodiment of the present invention.

FIG. 16 is a diagram illustrating a configuration of a shot data distribution system according to a third example embodiment of the present invention.

FIG. 17 is a diagram illustrating a function of a unification part according to the third example embodiment of the present invention.

FIG. 18 is another diagram illustrating a function of a unification part according to the third example embodiment of the present invention.

FIG. 19 is a diagram illustrating a configuration of a shot data distribution system according to a fourth example embodiment of the present invention.

FIG. 20 is a diagram illustrating a configuration of a shot data distribution system according to a fifth example embodiment of the present invention.

FIG. 21 is a diagram illustrating an operation of the shot data distribution system according to the fifth example embodiment of the present invention.

FIG. 22 is a diagram illustrating an operation of the shot data distribution system according to the fifth example embodiment of the present invention.

FIG. 23 is a diagram illustrating an operation of a shot data distribution system according to a sixth example embodiment of the present invention.

FIG. 24 is a diagram illustrating an operation of a shot data distribution system according to the sixth example embodiment of the present invention.

FIG. 25 is a diagram illustrating an operation of a shot data distribution system according to the sixth example embodiment of the present invention.

FIG. 26 is a diagram illustrating a configuration of a computer which forms a shot data distribution system of the present invention.

### EXAMPLE EMBODIMENTS

First, an outline of an example embodiment of the present invention will be described with reference to drawings. Note, in the following outline, reference signs of the drawings are denoted to each element as an example for the sake of convenience to facilitate understanding and are not intended to limit the present invention to any mode shown in the drawings. An individual connection line between blocks in the drawings, etc., referred to in the following description includes both one-way and two-way directions. A one-way arrow schematically illustrates a principal signal (data) flow and does not exclude bidirectionality. A program is executed via a computer apparatus, and the computer apparatus includes, for example, a processor, a storage device, an input device, a communication interface, and as needed, a display device. In addition, this computer apparatus is configured such that the computer apparatus can communicate with its internal device or an external device (including a computer) via the communication interface in a wired or wireless manner. In addition, although a port or an interface is present at an input/output connection point of an individual block in the relevant drawings, illustration of the port or the interface is omitted.

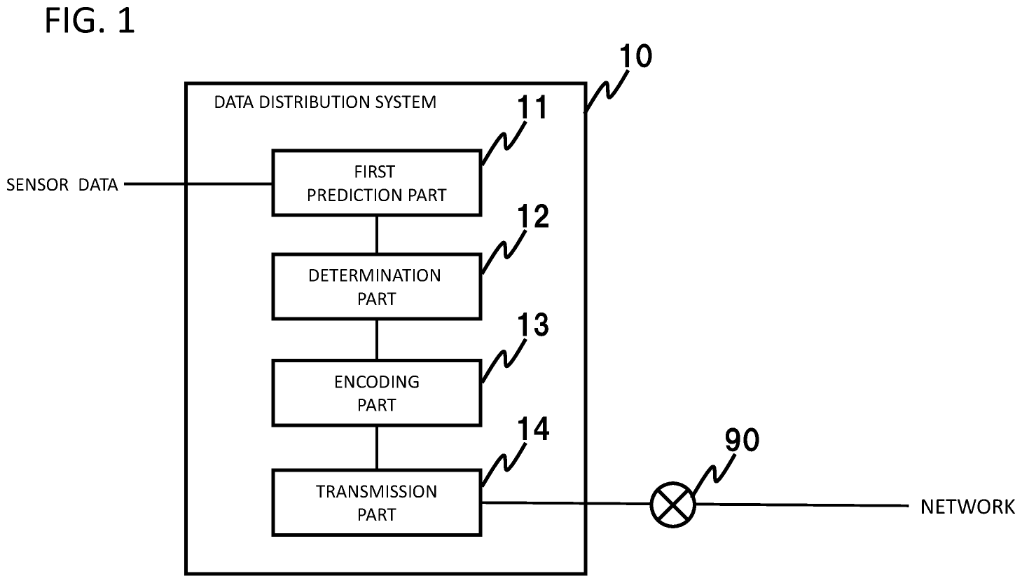

In an example embodiment, as illustrated in FIG. 1, the present invention can be realized by a data distribution system 10 which includes first prediction means 11, determination means 12, encoding means 13, and transmission means 14.

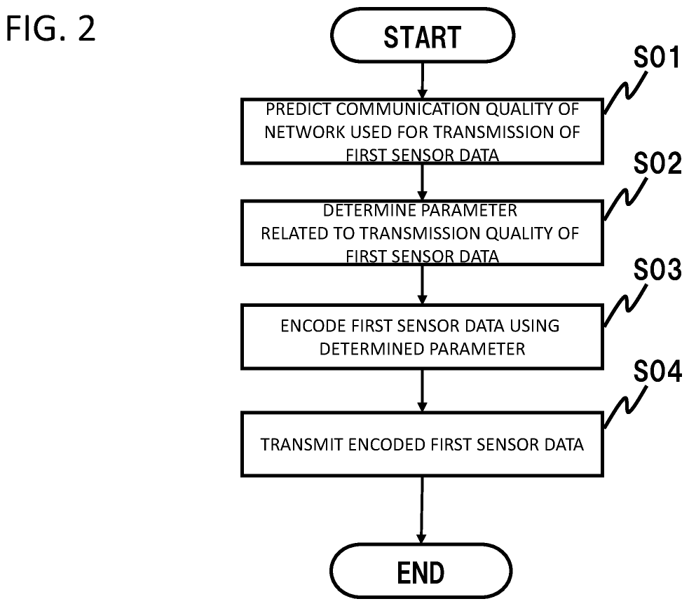

More concretely, as shown in FIG. 2, the first prediction means 11 predict communication quality of a network used for transmission of first sensor data based on the first sensor data (step S01). For example, in a case where the first sensor data is image data shot by various sensors, the first prediction means 11 predict communication quality of a network based on the image data.

The determination means 12 determine a parameter related to transmission quality of the first sensor data according to the communication quality predicted by the first prediction means (step S02). For example, in a case where a prediction result that communication quality of the network will degrade is acquired, the determination means 12 change a parameter related to transmission quality of the first sensor data to a value which matches degradation of the communication quality. For example, the determination means 12 change a video bit rate to a value lower than a reference value according to the communication quality.

The encoding means 13 encode the first sensor data using the parameter related to the transmission quality of the first sensor data (step S03).

The transmission means 14 transmit the encoded first sensor data via the network (step S04). As described above, a parameter related to the transmission quality of the first sensor data is determined according to the communication quality of the network. Therefore, in a case where a prediction result that communication quality of the network will degrade is acquired, a parameter related to the transmission quality of the first sensor data is determined to be a value according to the prediction result. Accordingly, it becomes possible to cope with a sudden fluctuation in communication throughput.

For example, in a case where sensor data is shot data, an object which is expected to affect communication quality of a network used for transmission of the shot data may be shot in the shot data. In this case, the first prediction means 11 predict that communication quality of the network used for transmission of the sensor data will degrade in the near future. The determination means 12 determine to change a parameter related to transmission quality of the sensor data to contents suitable for low communication quality of the network based on a prediction that the communication quality of the network used for transmission of the sensor data will degrade. For example, as a parameter related to the transmission quality of the sensor data, a value of a video bit rate (hereinafter, simply referred to “a bit rate”) can be used. Then, the encoding means 13 encode the sensor data using the parameter related to the transmission quality of the sensor data. By doing this, in a case where sensor data is shot data, it becomes possible to avoid degradation of shot data or abnormality at the time of reproduction by influence of an object which interferes transmission of the shot data.

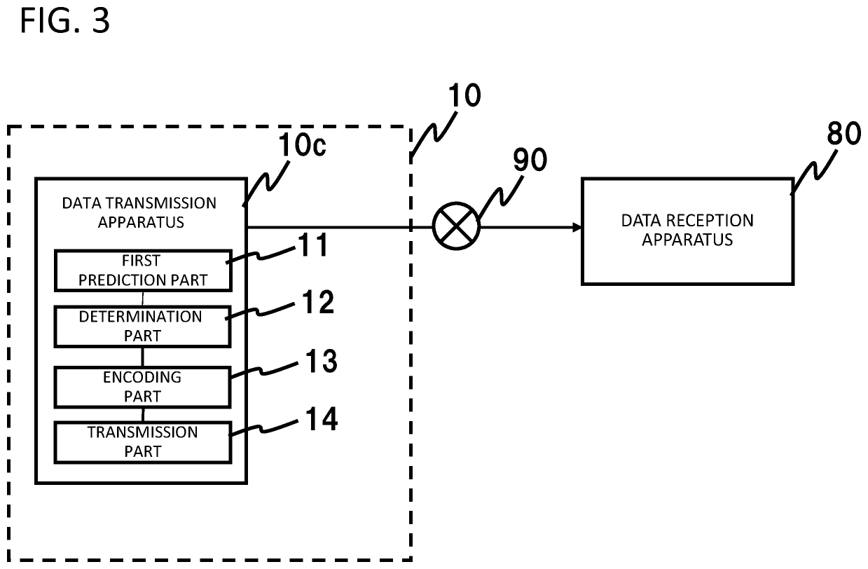

As shown in FIG. 3, the data distribution system 10 as described above can be realized by using a data transmission apparatus 10c which acquires and transmits first sensor data. According to this configuration, for example, in a case where sensor data is shot data (a video), there is an advantage that it is possible to predict communication quality using a high-quality video before being encoded and being transmitted.

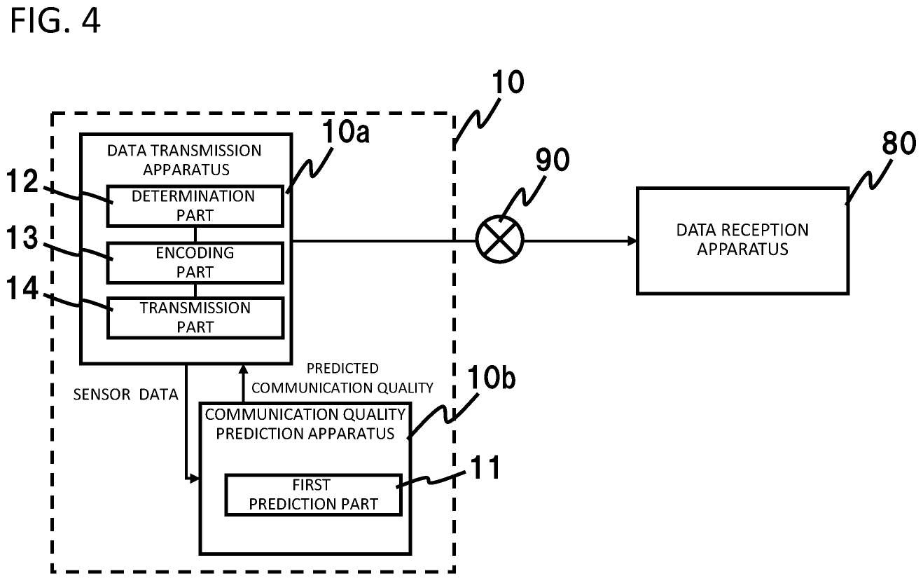

In addition, it is possible to employ a configuration in which each of processing means of the data distribution system 10 as described above are dispersedly placed on a plurality of apparatuses other than a mode in which each of processing means is placed on a single apparatus as shown in FIG. 3. For example, as shown in FIG. 4, it is possible to employ a configuration in which first prediction means 11 of a data distribution system 10 is placed on another apparatus (a communication quality prediction apparatus 10b). In this case, determination means 12, encoding means 13, and transmission means 14 are placed on a data transmission apparatus 10a. Furthermore, it is possible to use dedicated server or an MEC (Multi-access Edge Computing, or Mobile Edge Computing) server as a communication quality prediction apparatus 10b and to use a prediction algorithm which requires a large amount of processings. Furthermore, it is possible to employ a configuration in which a plurality of data transmission apparatuses 10a are connected to a communication quality prediction apparatus 10b and predicted communication results are transmitted to the plurality of data transmission apparatuses 10a. Note, in the example as shown in FIG. 4, determination means 12 is placed on the data transmission apparatuses 10a, the determination means 12 may be placed on the communication quality prediction apparatus 10b side. In this case, the communication quality prediction apparatus 10b becomes to transmit a parameter related to transmission quality of shot data in place of predicted communication quality to the data transmission apparatuses 10a.

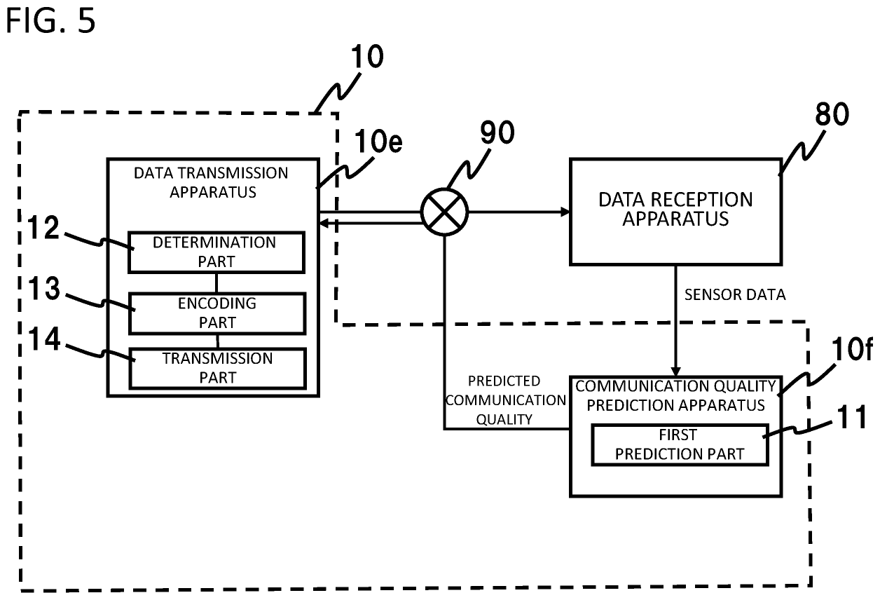

Furthermore, as shown in FIG. 5, the communication quality prediction apparatus 10b may be placed on a side of a data reception apparatus 80 side. In this case, a communication quality prediction apparatus 10f receives encoded sensor data from a data reception apparatus 80 and predicts communication quality of a network 90. Then, the communication quality prediction apparatus 10f provides a data transmission apparatuses 10e with predicted communication quality. The communication quality prediction apparatus 10f may receive shot data from communication apparatus which makes up the network 90. Note, in an example as shown in FIG. 5, determination means 12 are placed on the data transmission apparatuses 10e, the determination means 12 may be placed on the communication quality prediction apparatus 10f side. In this case, the communication quality prediction apparatus 10f becomes to transmit a parameter related to transmission quality of sensor data in place of predicted communication quality to the data transmission apparatus 10e. Furthermore, in a case where a data reception apparatus 80 is placed on a cloud platform which provides a cloud computing service, the communication quality prediction apparatus 10f may be placed on the cloud platform.

### First Example Embodiment

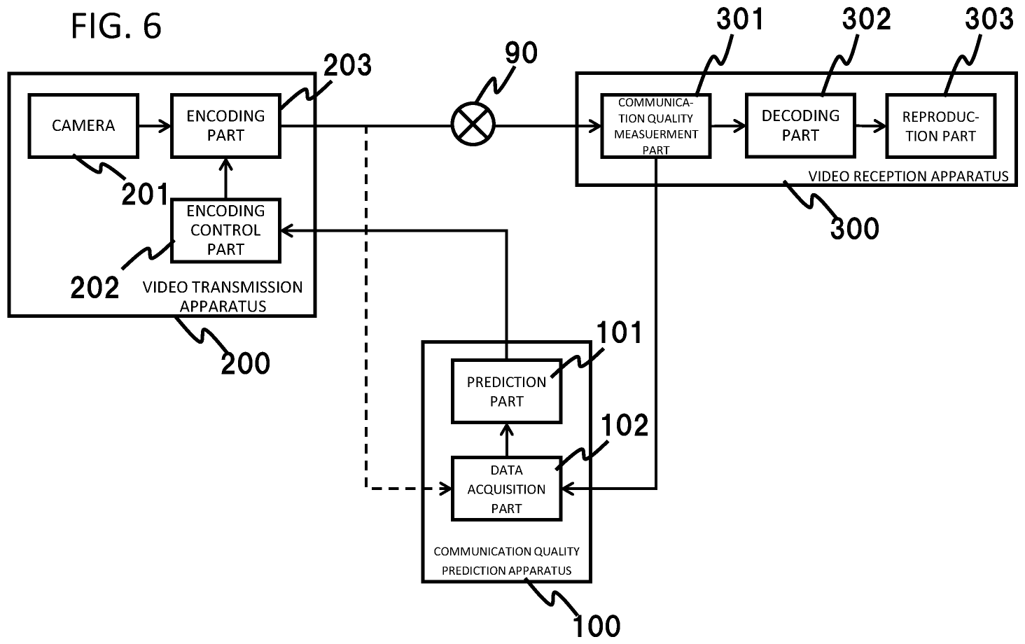

Next, a first example embodiment in which the present invention is applied to a system for live distribution of a video shot by a camera will be described in detail with reference to drawings. FIG. 6 is a diagram illustrating a configuration of a shot data distribution system according to the first example embodiment of the present invention. With reference to FIG. 6, a configuration in which a video transmission apparatus 200 and a video reception apparatus 300 are connected via a network 90 is shown. Furthermore, a communication quality prediction apparatus 100 is provided in the shot data distribution system. The communication quality prediction apparatus 100 can acquire shot data from the video transmission apparatus 200 and can acquire communication quality at the time of reception of past shot data from the video reception apparatus 300.

The video transmission apparatus 200 is an apparatus which transmits shot data shot by a camera 201 to the video reception apparatus 300. The video transmission apparatus 200 includes the camera 201, an encoding control part 202, and an encoding part 203. The video transmission apparatus 200 corresponds to the data transmission apparatus 10a and 10e as described above. The camera 201 is a camera which is mounted on a movable body and shoots a video which is a target of live distribution (corresponding to a first apparatus). The encoding control part 202 corresponds to the determination means 12 as described above and determines a bit rate for encoding a video base on a prediction value of communication quality received from the communication quality prediction apparatus 100. The encoding part 203 corresponds to the encoding means 13 and the transmission means 14 as described above and encodes a video with a bit rate determined in the encoding control part 202 and transmits it to the communication quality prediction apparatus 100 and the video reception apparatus 300, respectively. Note, a bit rate can be altered by using at least one or more of resolution of a video, a frame rate, a target bit rate, QP (Quantization Parameter), CRF (Constant Rate Factor), an encoding method (a type of CODEC), and so on. When a bit rate is altered, in a case where priorities and so on of information elements to be changed are determined in advance by a user, the bit rate may be altered by changing the information elements according to the priorities. By doing this, it becomes possible to alter the bit rate in accordance with demand of the user.

The video reception apparatus 300 is an apparatus for receiving shot data shot by the camera 201 via the video transmission apparatus 200. The video reception apparatus 300 includes a communication quality measurement part 301, a decoding part 302, and a reproduction part 303. The video reception apparatus 300 corresponds to the data reception apparatus 80 as described above. The communication quality measurement part 301 measures communication quality at the time of receiving a video from the video transmission apparatus 200 and transmits it to the communication quality prediction apparatus 100.

The decoding part 302 decodes a video received from the video transmission apparatus 200. The reproduction part 303 reproduces a video decoded by the decoding part 302.

The communication quality prediction apparatus 100 is an apparatus which predicts communication quality of a network that the video transmission apparatus 200 uses at the time of transmitting data to the video reception apparatus 300. The communication quality prediction apparatus 100 includes a prediction part 101 and a data acquisition part 102. The data acquisition part 102 receives a video from the video transmission apparatus 200 and provides the prediction part 101 with it. In addition, the data acquisition part 102 receives past communication quality from the video reception apparatus 300 and provides the prediction part 101 with it. The prediction part 101 predicts future communication quality of the network 90 based on the past communication quality acquired from the video reception apparatus 300 and the video received from the video transmission apparatus 200. A prediction method of future communication quality of the network 90 in the prediction part 101 will be described later in detail along with description of an operation of the present example embodiment,

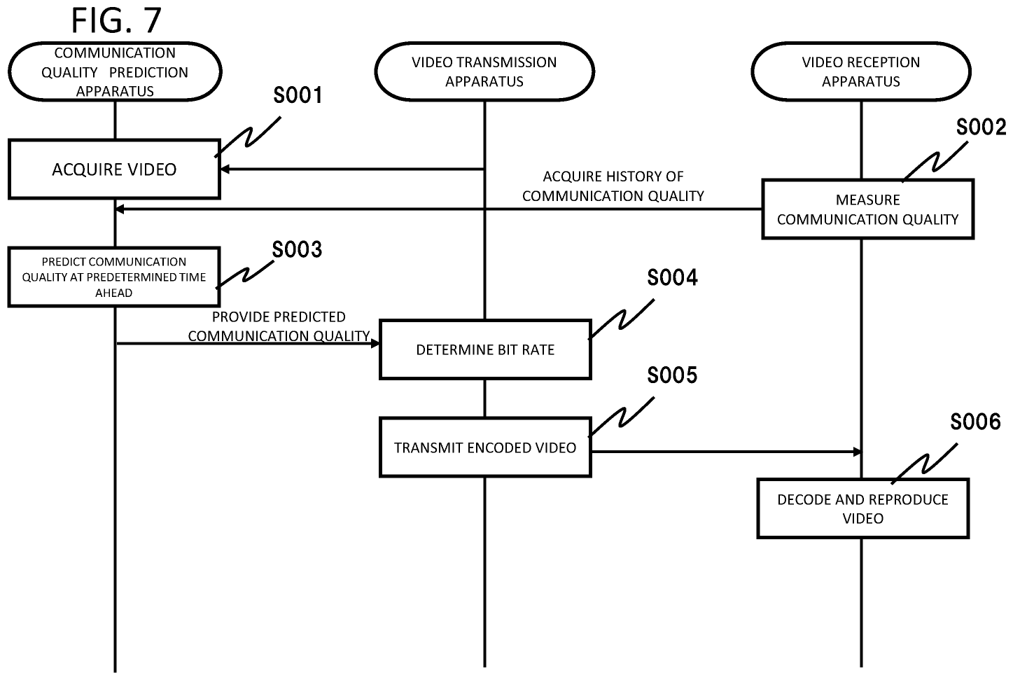

Next, an operation of the present example embodiment will be described in detail with reference to drawings. FIG. 7 is a sequence diagram illustrating an operation of the shot data distribution system according to the first example embodiment of the present invention. With reference to FIG. 7, the communication quality prediction apparatus 100 acquires a video (shot data) from the video transmission apparatus 200 at a predetermined time interval (step S001). Note, the predetermined time interval is determined according to a system configuration, quality of a network between the video transmission apparatus 200 and the communication quality prediction apparatus 100, and performance of the communication quality prediction apparatus 100. For example, in a case where the video transmission apparatus 200 and the communication quality prediction apparatus 100 are implemented on the same server or they are connected with a high speed network or in a case where performance of the communication quality prediction apparatus 100 is high or it is required to raise prediction accuracy of the prediction part 101, the communication quality prediction apparatus 100 may acquire all frames from the video transmission apparatus 200. In such case where, for example, the video transmission apparatus 200 is transmitting a video (shot data) at 30 fps, the predetermined time interval is 30 fps. Of course, the communication quality prediction apparatus 100 may acquire a video (shot data) from the video transmission apparatus 200 by decimating it. In this case, the predetermined time interval is less than or equal to 30 fps.

Meanwhile, the video reception apparatus 300 has measured communication quality of the network 90 at the time when it previously received a video from the video transmission apparatus 200 (step S002). In the present example embodiment, in the following description, it is assumed that the video reception apparatus 300 measures communication throughput as communication quality and provides the communication quality prediction apparatus 100 with time-series data thereof. For example, communication throughput can be calculated by dividing a size of each video frame by a time required for reception of the frame (a time between reception of a first packet and reception of a last packet).

The communication quality prediction apparatus 100 predicts communication throughput of the network 90 at a predetermined time ahead from a current time as future communication quality, using past communication throughput acquired from the video reception apparatus 300 and a video (shot data) acquired from the video transmission apparatus 200 (step S003). The communication quality prediction apparatus 100 transmits the predicted communication throughput to the video transmission apparatus 200.

Concretely, the communication quality prediction apparatus 100 predicts future communication throughput based on time-series data of communication throughput (history data of communication quality) acquired from the video reception apparatus 300. As a prediction method of this communication throughput, for example, a method for predicting probability distribution of time-series data based on a prediction model created in advance can be used. Furthermore, the communication quality prediction apparatus 100 checks whether or not an event which affects communication throughput of the network 90 at a predetermined time ahead is occurring based on a video (shot data) acquired from the video transmission apparatus 200. As a result of checking, in a case where it is determined that an event which affects communication throughput at a predetermined time ahead is occurring, the communication quality prediction apparatus 100 increases or decreases the prediction value of communication throughput according to a content thereof.

The video transmission apparatus 200 which has acquired the predicted communication throughput determines an appropriate bit rate based on the predicted communication throughput (step S004). Note, a setting of a bit rate may be achieved by setting any one or more of a target bit rate, QP (Quantization Parameter), CFR (Constant Rate Factor). Furthermore, a resolution or a frame rate may be increased or decreased. For example, in a case where communication throughput is lower than a lower limit in a predetermined range, the video transmission apparatus 200 determines to decrease any one of or both of a resolution and a frame rate in addition to a bit rate of a video to be transmitted to the video reception apparatus 300. In a case where only resolution is decreased, a smooth video with a high frame rate can be distributed even if a bit rate is decreased. In a case where only a frame rate is decreased, degradation of image quality of each video frame can be reduced if a bit rate is decreased. For example, in a case where communication throughput exceeds an upper limit of a predetermined range, the video transmission apparatus 200 decides to increase resolution and a frame rate in addition to a bit rate of a video to be transmitted to the video reception apparatus 300. Note, a configuration for increasing or decreasing a bit rate can be employed by increase or decrease in any one or more of resolution, a frame rate, QP, and CFR according to a setting predetermined in advance when the bit rate is increased or decreased.

Note, the predetermined be compared with communication throughput can be increased or decreased according to a bit rate which is currently used. For example, when a bit rate becomes to exceed communication throughput, packet loss will occur and whereby disturbance of image quality will appear. In addition, in a state where a bit rate is substantially below communication throughput, network resources cannot be used effectively. Therefore, a proactive coping becomes possible by setting a value which takes into account a bit rate as a predetermined range and comparing it with predicted communication throughput.

The video transmission apparatus 200 encodes a video with the determined bit rate and transmits it to the video reception apparatus (step S005). The video reception apparatus 300 decodes and reproduces received shot data (step S006).

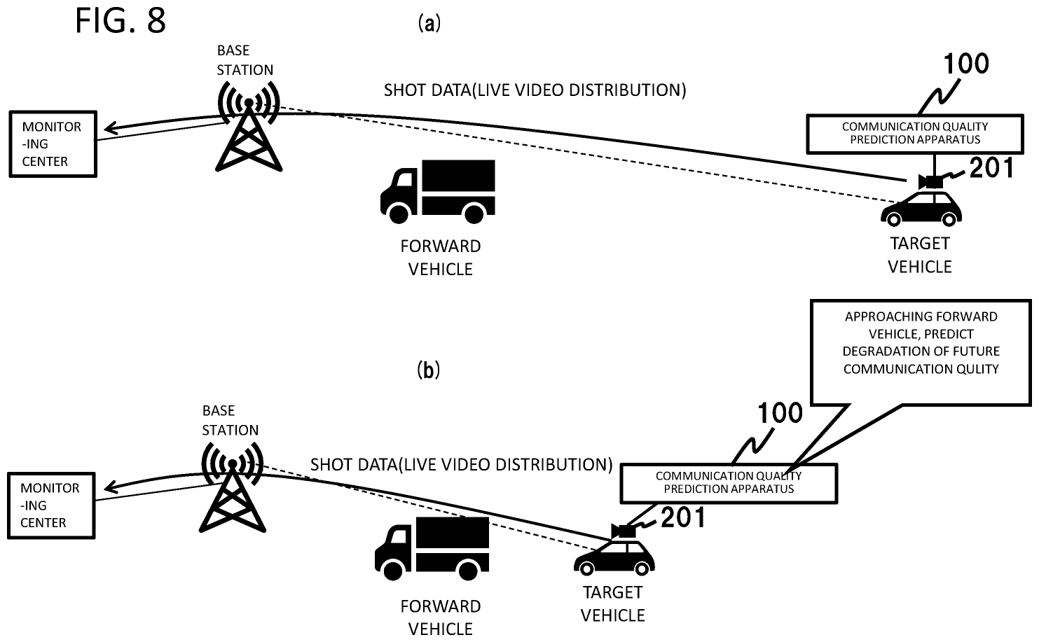

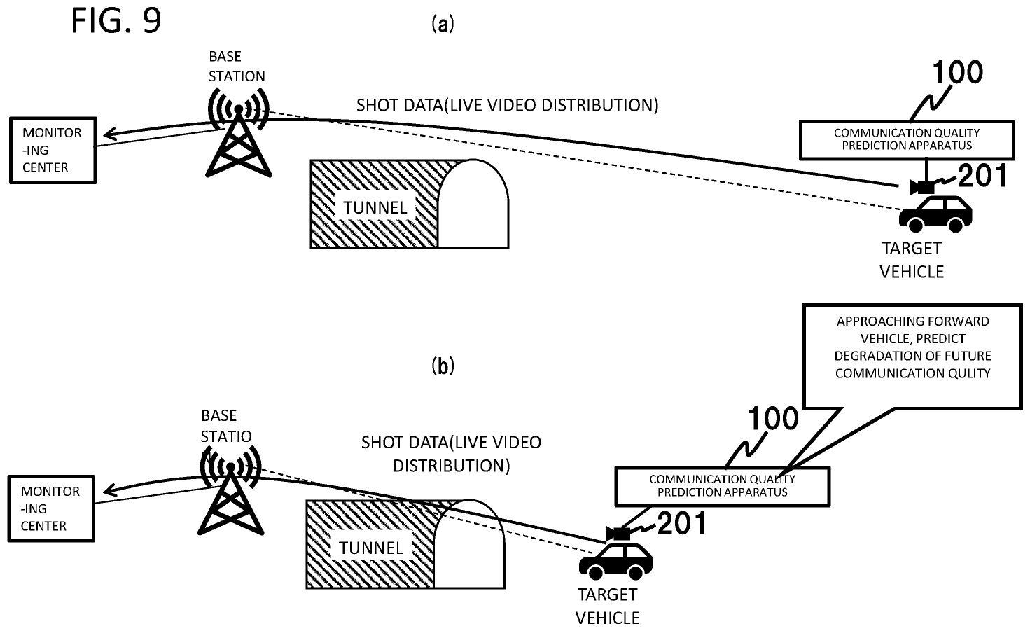

An operation of the present example embodiment will be more concretely described using FIGS. 8 and 9. In the following description, a video transmission apparatus 200 is mounted on a vehicle (target vehicle) as an on-board terminal and transmits a video of a view ahead of the vehicle shot by a camera 201 to a monitoring center. The video reception apparatus 300 is installed in the monitoring center and decodes and reproduces shot data received from the vehicle (target vehicle). Furthermore, the communication quality prediction apparatus 100 is assumed to be mounted on the vehicle (target vehicle). In addition, it is assumed that a wireless network such as 5G (including local 5G), an LTE (Long Term Evolution), a wireless LAN (Local Area Network) and so on, are used between the vehicle (target vehicle) and a base station and communication is performed with a frequency such as millimeter waves or the like at which communication quality will fluctuate by influence of a shield.

The communication quality prediction apparatus 100 mounted on the target vehicle predicts future (at a predetermined time ahead) communication throughput based on time-series data of past communication throughput acquired from the video reception apparatus 300 in the monitoring center. In addition, the communication quality prediction apparatus 100 checks whether or not an event which affects future communication throughput is occurring based on a video (shot data) acquired from the camera 201. For example, as shown in an upper part (a) in FIG. 8, in a case where an inter-vehicle distance between a target vehicle and a forward vehicle is longer than or equal to a predetermined distance, Line-Of-Sight (LOS) communication is secured between the base station and the vehicle (target vehicle) as shown in a broken line of FIG. 8. In this case, the communication quality prediction apparatus 100 determines that an event which affects future communication throughput is not occurring, predicts future communication throughput from past communication throughput, and notifies video transmission apparatus 200. The video transmission apparatus 200 encodes a video with a bit rate determined based on the communication throughput predicted from the past communication throughput and transmits it to the monitoring center.

Meanwhile, as shown in a lower part (b) in FIG. 8, a target vehicle and a forward vehicle are close and there is the forward vehicle between a base station and the vehicle (target vehicle), whereby there may result in Non-Line-Of-Sight (NLOS) communication as shown in a broken line of FIG. 8. In this case, the forward vehicle is shot large in shot data. The communication quality prediction apparatus 100 determines that an event which affects future communication throughput is occurring from such a video, predicts future communication throughput by taking account of influence of the forward vehicle, and notifies the video transmission apparatus 200. In this case, the video transmission apparatus 200 encodes a video with a bitrate determined based on communication throughput estimated to be low due to presence of the forward vehicle and transmits to the monitoring center. By this, it become possible to continue distribution of a stable live video under a situation in which a distance to the forward vehicle is shortened and whereby communication throughput rapidly drops.

Note, in the example as described above, it is assumed to determine that an event which affects future communication throughput is occurring on the basis that the forward vehicle is shot large in shot data, but a method for determining presence or absence of occurrence of an event which affects future communication throughput is not limited to the method. For example, in a case where the forward vehicle shot in the shot data successive in terms of time is enlarging, it can be determined that the target vehicle is approaching the forward vehicle. It is possible to estimate a moment at which the communication throughput is affected according to the degree of approaching (approaching velocity). Furthermore, in a case where a state in which the forward vehicle is shot large in shot data for a predetermined period of time continues, it can be determined that the target vehicle keeps a state in which the target vehicle is close to the forward vehicle.

Furthermore, an event which affects future communication throughput is not limited to that a vehicle (target vehicle) approaches the forward vehicle. For example, as shown in (a) and (b) of FIG. 9, when a vehicle (target vehicle) approaches a tunnel and so on, it is possible to determine a bit rate based on communication throughput estimated to be low. Of course, there is a tunnel in which communication throughput does not decrease because a base station is placed inside according to a tunnel. In that case, the communication quality prediction apparatus 100 may identify a tunnel in which decrease in communication throughput does not occur from appearance or location or the like. Of course, it is possible to employ a method in which after it is predicted that decrease in communication throughput occurs, a bit rate may be restored based on actual communication throughput.

Furthermore, there is a case where future throughput is largely improved due to an event that an inter-vehicle distance between vehicles become long, that a vehicle exits a tunnel or the like from the states of (b) of FIG. 8 or (b) of FIG. 9. In this case, the communication quality prediction apparatus 100 predicts future communication throughput by taking account of these events and notifies the video transmission apparatus 200. Then, the video transmission apparatus 200 encodes a video with a bit rate based on communication throughput highly estimated and transmit it to the monitoring center. By this, after improvement of communication throughput, distribution of a live video with high image quality can be promptly restarted.

As described above, according to the present example embodiment, while future communication throughput predicted based on the past communication throughput is basically used, when an event which affects future communication throughput is foreseen from a video, the communication throughput can be adjusted.

### Second Example Embodiment

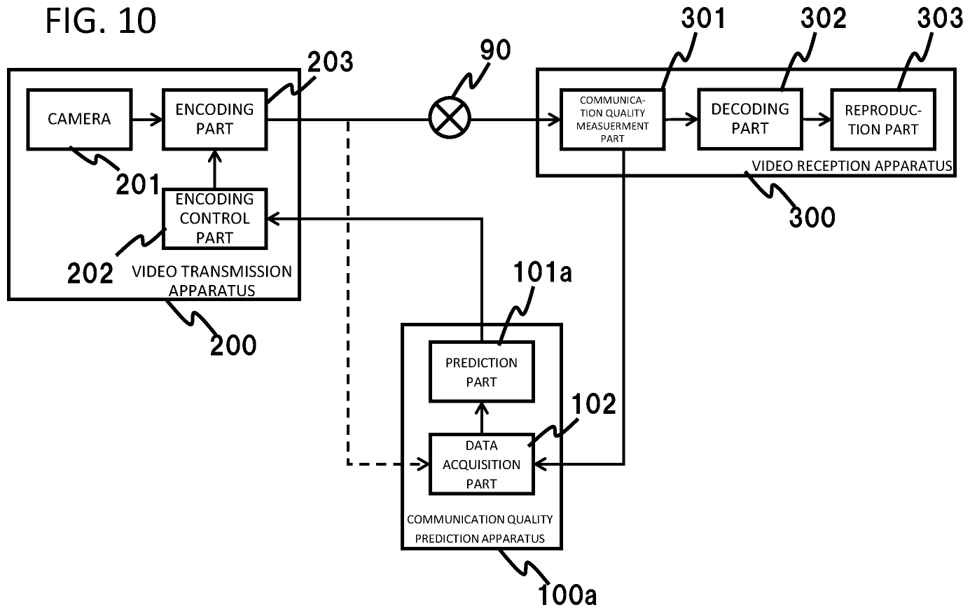

Next, a second example embodiment in which a prediction part of a communication quality prediction apparatus is modified will be described in detail with reference to drawings. FIG. 10 is a diagram illustrating a configuration of a shot data distribution system according to the second example embodiment of the present invention. The shot data distribution system according to the second example embodiment is different from the first example embodiment in a configuration of a prediction part 101a in a communication quality prediction apparatus 100a. Because rest of the configuration is the same as that of the first example embodiment as shown in FIG. 6, the difference will be mainly described below.

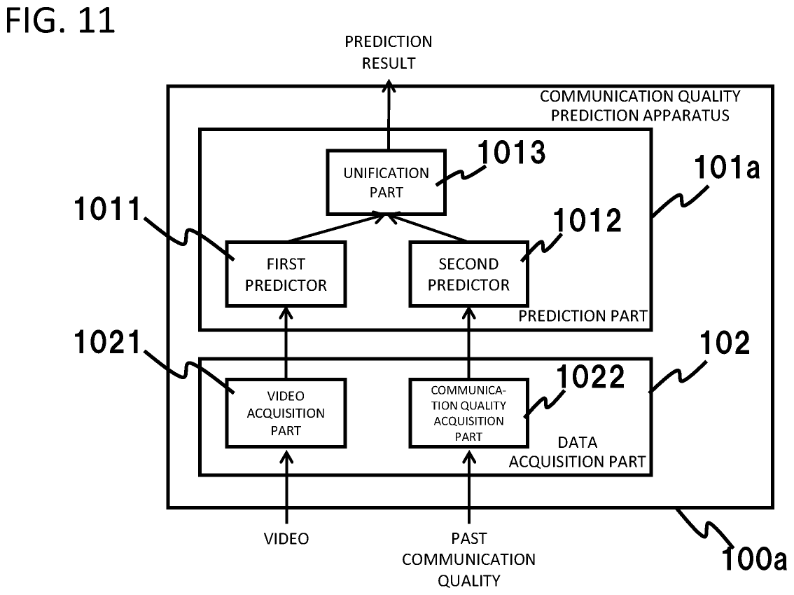

FIG. 11 is a diagram illustrating a configuration of a communication quality prediction apparatus according to the second example embodiment of the present invention. With reference to FIG. 11, a configuration of a communication quality prediction apparatus 100a including a prediction part 101a and a data acquisition part 102 is shown.

The data acquisition part 102 includes a video acquisition part 1021 and a communication quality acquisition part 1022. The video acquisition part 1021 acquires a video (shot data) form the video transmission apparatus 200 and provides the prediction part 101a with it. The communication quality acquisition part 1022 acquires past communication quality of a network 90 from a video reception apparatus 300 and provides the prediction part 101a with it.

The prediction part 101a includes a first predictor 1011, a second predictor 1012 and a unification part 1013. In the present example embodiment, the first predictor 1011 functions as a first prediction means, and the second predictor 1012 functions as a second prediction means. Concretely, the first predictor 1011 predicts future communication quality based on a video (shot data) transmitted from the video transmission apparatus 200 and outputs to the unification part 1013. Such first predictor 1011 can be, for example, configured by a machine learning model which outputs a prediction value using a video (shot data) transmitted from the video transmission apparatus 200 as an input. Furthermore, for example, the first predictor 1011 can be configured by using a model which identifies an object shot in a video (shot data) transmitted from the video transmission apparatus 200, calculates degree of influence on communication throughput from a size thereof and a distance, and output a prediction value.

The second predictor 1012 predicts future communication quality based on past communication quality (time-series data of communication throughput) of the network 90 transmitted from the video reception apparatus 300 and outputs to the unification part 1013. The unification part 1013 unifies communication quality predicted by the first predictor 1011 and communication quality predicted by the second predictor 1012 according to a predetermine rule and outputs a prediction value of future communication quality. The predetermined rule may be, for example, a rule that a result of weighting of a prediction value of the first predictor 1011 and a prediction value of the second predictor 1012 by a predetermined equation is outputted as a prediction value. Furthermore, the predetermined rule may be a rule that a prediction value of the first predictor 1011 and a prediction value of the second predictor 1012 are compared and lower one is employed and outputted as a prediction value.

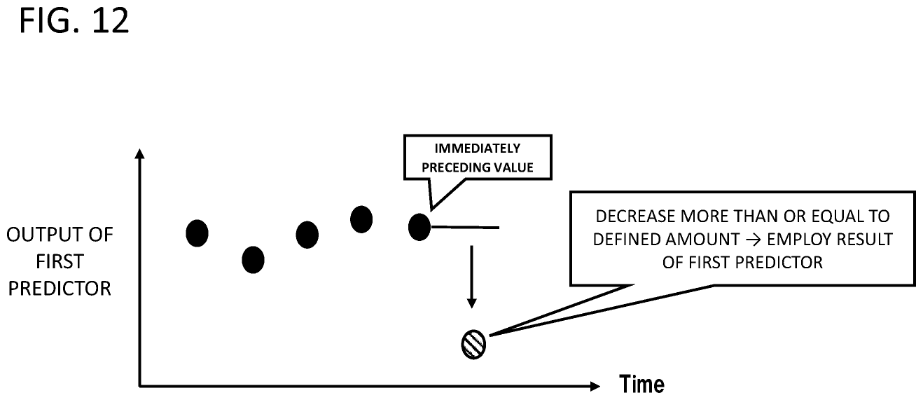

Furthermore, a unification processing in the unification part 1013 may be a processing which employs either one of a prediction value of the first predictor 1011 and a prediction value of the second predictor 1012 based on a change in an amount of the first predictor 1011 below.

[A sudden change 1 of a prediction value of the first predictor] FIG. 12 is a diagram illustrating another example of a unification processing of the unification part 1013. Solid black circles in FIG. 12 indicate an output of the first predictor (communication quality predicted based on a video). For example, as shown in FIG. 12, in a case where decrease more than or equal to a defined amount in the output of the first predictor 1011 occurs, the unification part 1013 employs the output of the first predictor 1011. Meanwhile, in a case where decrease of more than or equal to the defined amount in the output of the first predictor 1011 does not occurs, the unification part 1013 employs the output of the second predictor 1012. By employing this unification processing, it is possible to adequately adopt decrease in communication quality caused by an unexpected event (for example, approaching a forward vehicle, passing through a tunnel) from a transition of communication throughput.

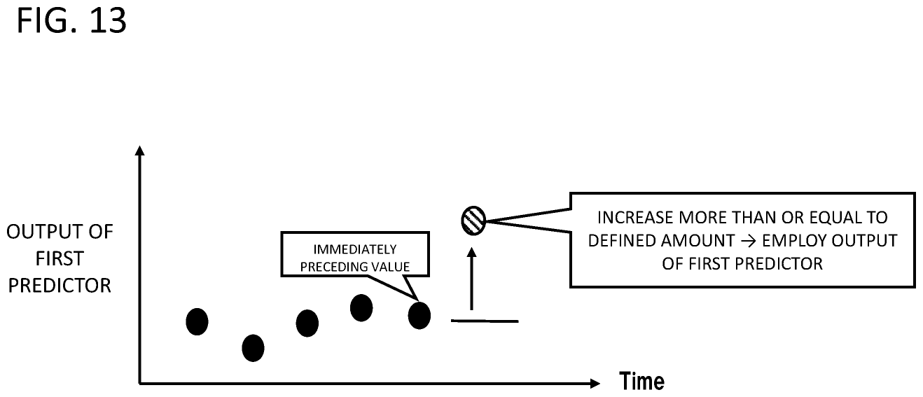

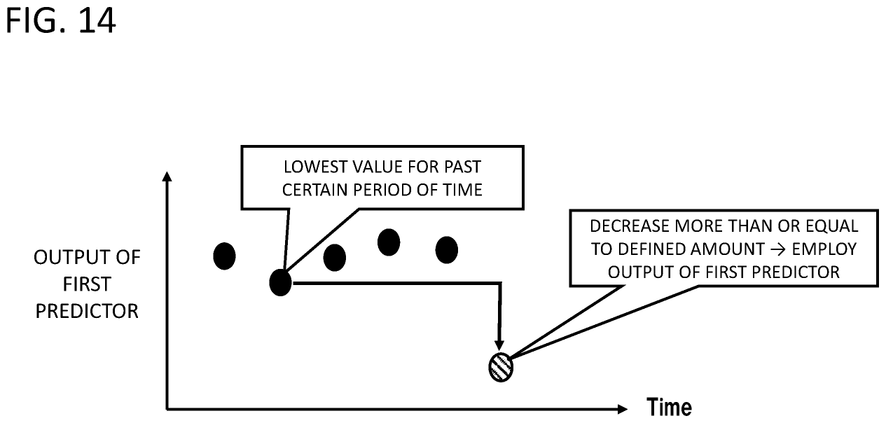

Furthermore, for example, as shown in FIG. 13, in a case where increase of more than or equal to a defined amount in the output of the first predictor 1011 occurs, the unification part 1013 may employ the output of the first predictor 1011. Meanwhile, in a case where decrease of more than or equal to the defined amount in the output of the first predictor 1011 does not occurs, the unification part 1013 employs the output of the second predictor 1012. By employing this unification processing, it is possible to adequately adopt rapid recovery of communication throughput caused by recovering from states as indicated in (b) of FIG. 8 or (b) of FIG. 9 (for example, approaching a forward vehicle, passing through a tunnel) to states as indicated in (a) of FIG. 8 or (a) of FIG. 9 (for example, securement of a distance from a forward vehicle, running outside of a tunnel).

[A sudden change 2 of a prediction value of the first predictor] FIG. 14 is a diagram illustrating another different example of a unification processing of a unification part 1013. In an example as shown in FIG. 14, in a case where decrease of more than or equal to a defined amount from a lowest value for a past certain period of time in the output of the first predictor 1011 occurs, the unification part 1013 employs the output of the first predictor 1011. Meanwhile, in a case where the output of the first predictor 1011 does not satisfy a condition as described above, the unification part 1013 employs the output of the second predictor 1012. By employing this unification processing, it is possible to adequately adopt decrease in communication quality caused by an unexpected event from a transition of communication throughput.

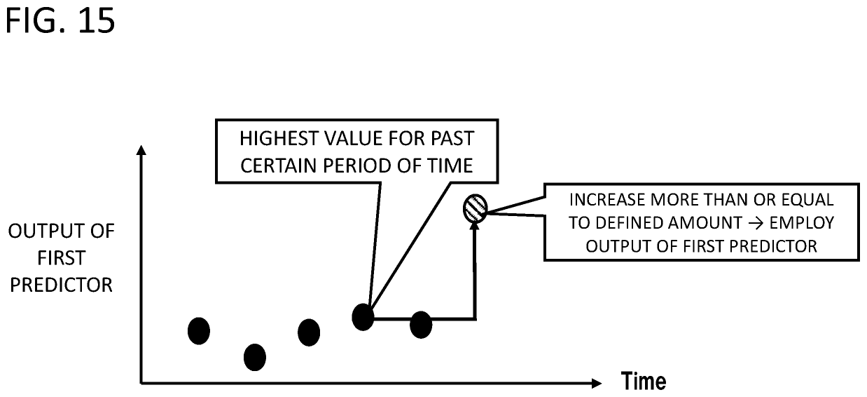

Furthermore, for example, as shown in FIG. 15, in a case where increase of more than or equal to a defined amount from a highest value for a past certain period of time in the output of the first predictor 1011 occurs, the unification part 1013 may employ the output of the first predictor 1011. Meanwhile, in a case where the output of the first predictor 1011 does not satisfy a condition as described above, the unification part 1013 employs the output of the second predictor 1012. By employing this unification processing, it is possible to adequately adopt rapid recovery of communication throughput caused by recovering from states as indicated in (b) of FIG. 8 or (b) of FIG. 9 (for example, approaching a forward vehicle, passing through a tunnel) to states as indicated in (a) of FIG. 8 or (a) of FIG. 9 (for example, securement of a distance from a forward vehicle, running outside of a tunnel).

Note, “a defined amount” as described above can be changed according to performance of a camera 201, a content of live distribution image, or a type of monitoring operation by a monitoring center. For example, in a case where performance of the camera 201 is low, a change of an output of the first predictor 1011 likely occurs by noise and so on or degradation in a shot condition. In such a case, it is possible to avoid an erroneous determination due to a noise by setting “a defined amount” functioning as a threshold to be a value larger than a criterion. For example, in a case where performance of the camera 201 is low, the output of the first predictor 1011 becomes hard to be employed by setting “a defined amount” to be a value larger than a standard value. As a result, it is possible to avoid an erroneous determination due to performance of the camera 201 or weather. Furthermore, in a case where continuous distribution of a video is required rather than image quality, “a defined amount” may be set to be a value smaller than a criterion. As a result, it is possible to raise resilience against a rapid change of throughput due to a suddenly happened event. For example, by setting a value smaller than a standard value as “a defined amount”, the output of the first predictor 1011 becomes easy to be employed. As a result, it is possible to stably distribute a video under a condition where suddenly happened events frequently occur.

Furthermore, in the examples as shown in FIGS. 12 to 15, a latest output of the first predictor 1011 and a past output of the first predictor 1011 are compared, a latest output of the first predictor 1011 may be compared with actual communication throughput transmitted from a video reception apparatus 300.

Furthermore, in the example embodiment as described above, it is described that a unification part 1013 determines whether or not to employ a prediction value of the second predictor 1012 based on an output change of the first predictor 1011 but a unification processing of prediction values at the unification part 1013 is not limited thereto. For example, the unification part 1013 may compare a prediction value of the first predictor 1011 with a prediction value of the second predictor 1012 and employ a lower prediction value.

### Third Example Embodiment

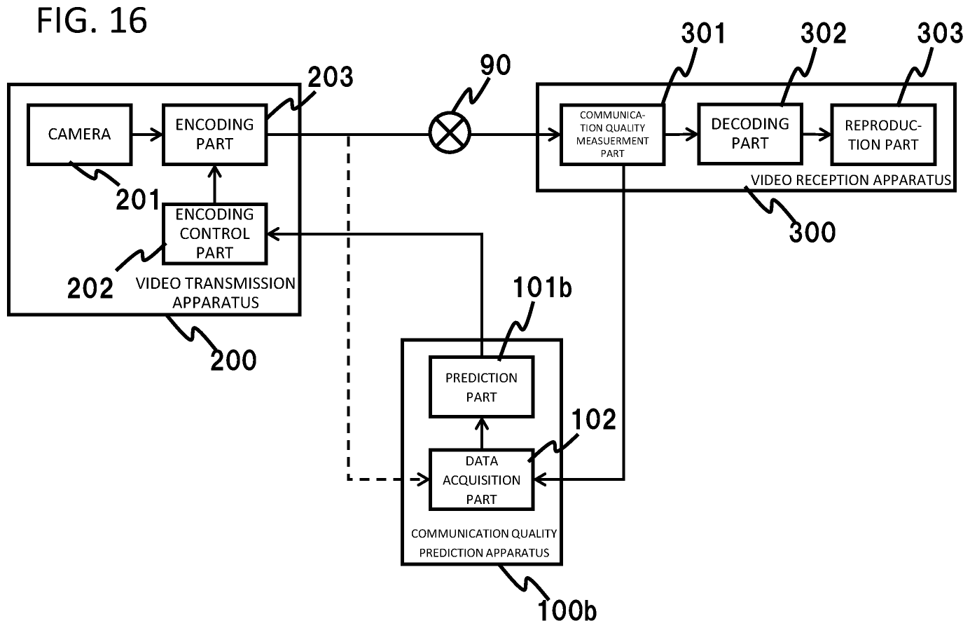

Next, a third example embodiment in which a configuration of a prediction part of a communication quality prediction apparatus is modified will be described in detail with reference to drawings. FIG. 16 is a diagram illustrating a configuration of a shot data distribution system according to the third example embodiment of the present invention. A configuration of a prediction part 101b of a communication quality prediction apparatus 100b in the shot data distribution system according to the third example embodiment is different from that of the second example embodiment. Because the rest of the configuration is mostly common to those of the second example embodiment as shown on FIG. 10 and FIG. 11, a difference between them is mainly described below.

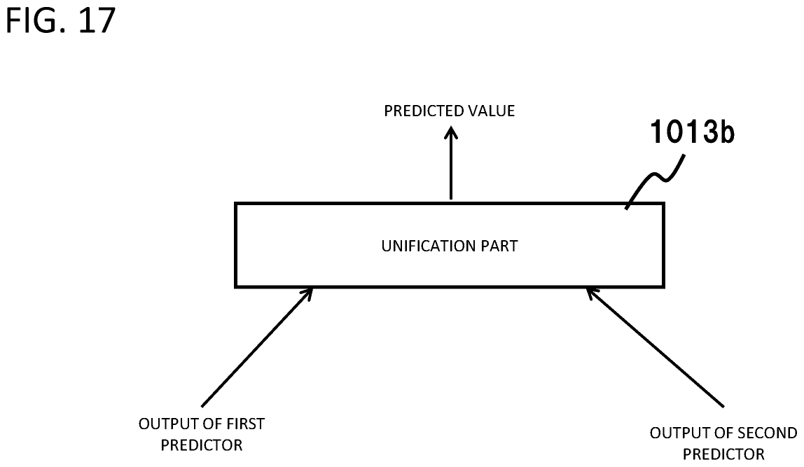

FIG. 17 is a diagram illustrating a configuration of a unification part 1013b in the prediction part 101b in the communication quality prediction apparatus 100b according to the third example embodiment of the present invention. With reference to FIG. 17, an output of a first predictor 1011 and an output of a second predictor 1012 the unification part 1013b are supplied to the unification part 1013b. With using these as inputs, the unification part 1013b outputs more likelihood prediction value.

This unification part 1013b can be configured by a Vector AutoRegression model (VAR model), a neural network and so on. For example, in a case where a Vector AutoRegression model is used, a model can be created by identifying parameters from time-series data of an output of the first predictor 1011 and time-series data of an output of the second predictor 1012. In a case where a neural network is used, a model can be created by learning using training-data including time-series data of an output of the first predictor 1011, time-series data of an output of the second predictor 1012, and actual communication throughput as a label(s) and using RNN (Recurrent Neural Network) and so on. Configuration methods of the unification part 1013b as described above are only examples and other statistical models and machine learning models can be employed.

Furthermore, in an example as shown in FIG. 17, although the output of the second predictor 1012 is supplied to one of inputs of the unification part 1013b, a past communication quality of a network 90 transmitted from a video reception apparatus 300 itself may be used in place of the output of the second predictor 1012. In this case, the second predictor 1012 may be omitted.

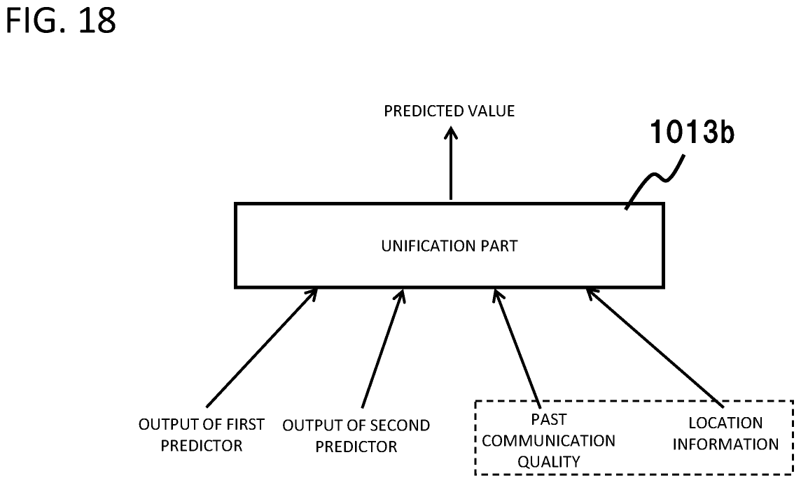

Furthermore, as shown in FIG. 18, past communication quality of a network 90 transmitted from a video reception apparatus 300 and position information of a camera 201 and the video transmission apparatus 200 may be supplied to the unification part 1013b and a prediction value taking account of these may be outputted. For example, by inputting past communication quality to the unification part 1013b, the unification part 1013 can further improve a prediction value of the second predictor. Furthermore, by inputting position information to the unification part 1013b, the unification part 1013 can outputs a prediction value taking account of a position. By doing this, in a case where a tunnel is shot in a video in the same way, it becomes possible to distinguish between a tunnel in which a communication throughput decreases and a tunnel in which a communication throughput does not decreases and to perform communication control according to each of potions.

According to the present example embodiment, it is possible to adequately adopt rapid drop of communication throughput and recovery of communication throughput thereafter as shown in (b) of FIG. 8 and (b) of FIG. 9 in the same way as that of the second example embodiment.

### Fourth Example Embodiment

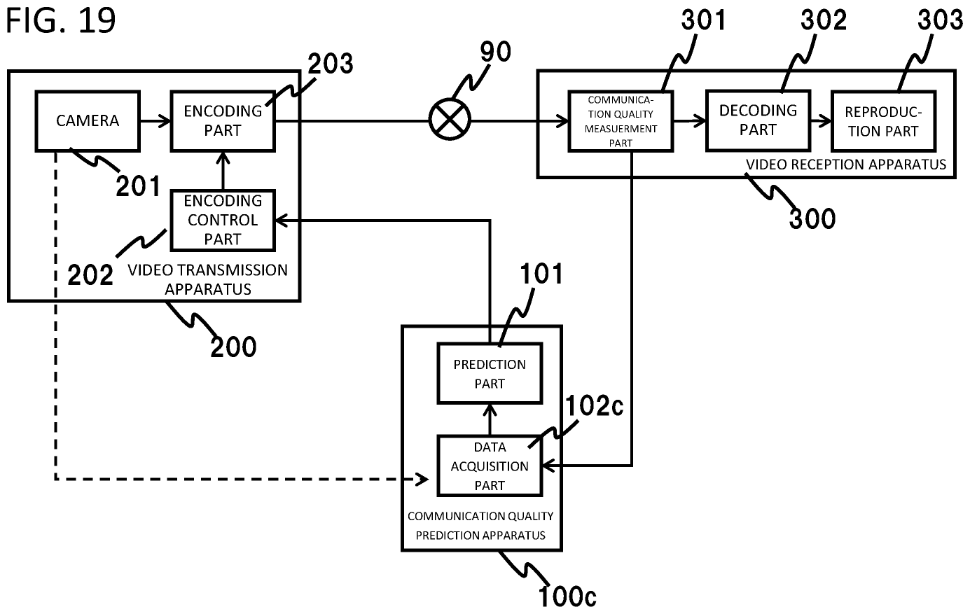

Next, a fourth example embodiment in which an input of a communication quality prediction apparatus is modified will be described in detail with reference to drawings. FIG. 19 is a diagram illustrating a configuration of a shot data distribution system according to the fourth example embodiment of the present invention. In the shot data distribution system according to the fourth example embodiment, an input of a communication quality prediction apparatus 100c directly receives a video (shot data) from a camera 201 in place of a video (shot data) encoded by a video transmission apparatus 200. The rest of the configuration is mostly common to those of the first to third example embodiment and, in the same way, a configuration of a communication quality prediction apparatus 100c may employ those of the first to third example embodiment.

According to the present example embodiment, it becomes possible to predict communication quality using a video with high image quality before encoding. Because the present example embodiment deals with a video (shot data) with a large size before encoding, it can be preferably adopted to a mode in which a communication quality prediction apparatus 100c is directly connected to a camera 201 by a cable and so on. For example, the present example embodiment can preferably be adopted to a case where a communication quality prediction apparatus 100c is mounted on a movable body along with a video transmission apparatus 200.

### Fifth Example Embodiment

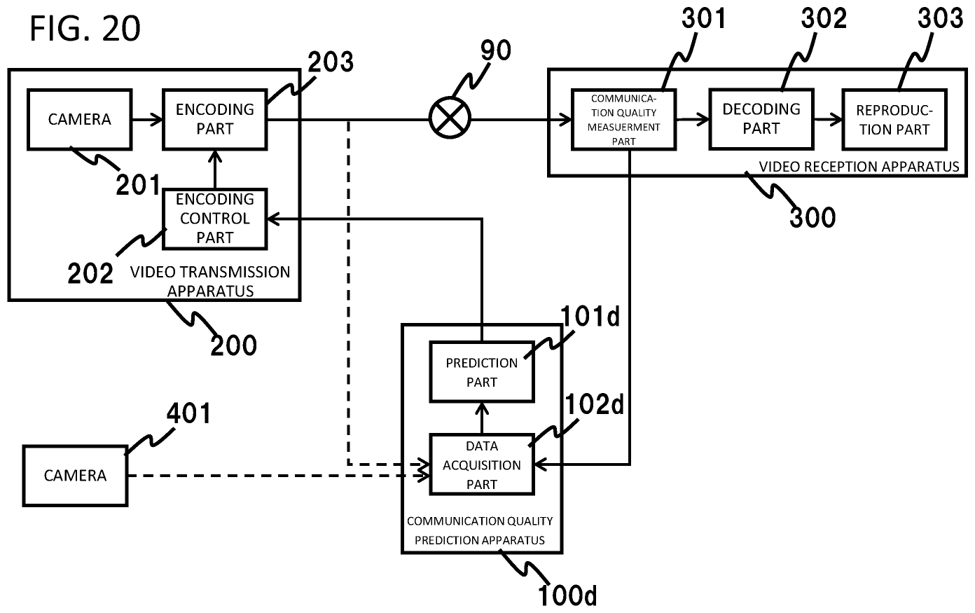

Next, a fifth example embodiment in which a plurality of cameras are connected to a communication quality prediction apparatus 100d will be described in detail with reference to drawings. FIG. 20 is a diagram illustrating a configuration of a shot data distribution system according to the fifth example embodiment of the present invention. In the shot data distribution system according to the fifth example embodiment, a second camera 401 is connected to a communication quality prediction apparatus 100d in addition to a camera 201 of a video transmission apparatus 200. Because the rest of the configuration is mostly common to those of the first to forth example embodiments, a difference between them is mainly described below.

Accordingly, in the present example embodiment, a data acquisition part 102d receives videos respectively from a video transmission apparatus 200 and a second camera 401 and provides a prediction part 101d with them. Here, the second camera 401 corresponds to a second apparatus and a video (shot data) received from the second camera 401 corresponds to a second sensor data.

A prediction part 101d predicts future communication quality of a network 90 based on past communication quality acquired from a video reception apparatus 300, a video received from a video transmission apparatus 200, and a video of a second camera.

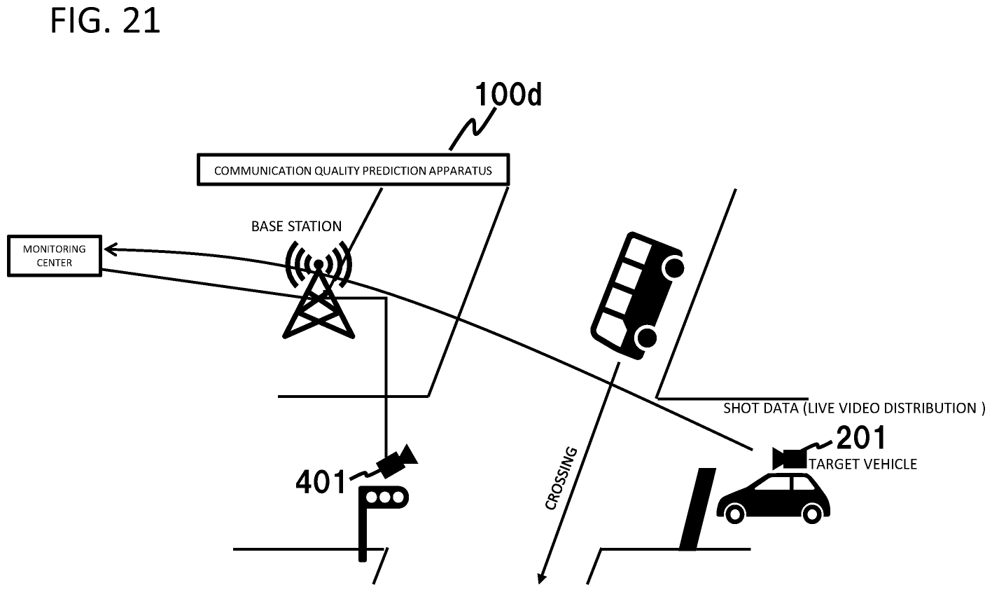

An operation of the present example embodiment will be described in detail with reference to drawings. FIG. 21 is a diagram illustrating an operation of the shot data distribution system according to the fifth example embodiment of the present invention. In an example as shown in FIG. 21, a video transmission apparatus 200 is mounted on a vehicle (target vehicle) as an on-board terminal and transmits a video of a view ahead of the vehicle shot by a camera 201 to a monitoring center. It is assumed that a communication quality prediction apparatus 100d is placed at a base station side. Furthermore, communication between a vehicle (target vehicle) and a base station is performed with a frequency such as millimeter waves or the like at which is likely to be affected by a shield. In the example as shown in FIG. 21, a camera which is installed near a traffic light of an intersection transmits a video (shot data) to the communication quality prediction apparatus 100d as a camera 401.

The communication quality prediction apparatus 100d placed at the base station side predicts future communication throughput based on time-series data of past communication throughput acquired from a video reception apparatus 300 in a monitoring center. In addition, the communication quality prediction apparatus 100d checks whether or not an event which affects future communication throughput is occurring based on a video (shot data) acquired from cameras 201, 401. For example, as shown in FIG. 21, in a case where there is no forward vehicle or obstacle in a road at which the target vehicle is running but a large vehicle is approaching toward an intersection from a crossing road, the large vehicle can be captured by the second camera 401. In this case, the communication quality prediction apparatus 100d determines that an event which affects future communication throughput is occurring from a video of the second camera 401, predicts future communication throughput by taking account of influence of the forward vehicle, and notifies the vehicle (target vehicle) of it. In this case, the video transmission apparatus 200 mounted on the vehicle (target vehicle) encodes a video with a bit rate determined based on the communication throughput in which influence of crossing of the large vehicle is estimated and transmits it to the monitoring center. Accordingly, it becomes possible to continue stable distribution of a live video under a condition where the communication throughput is decreased due to crossing of the large vehicle.

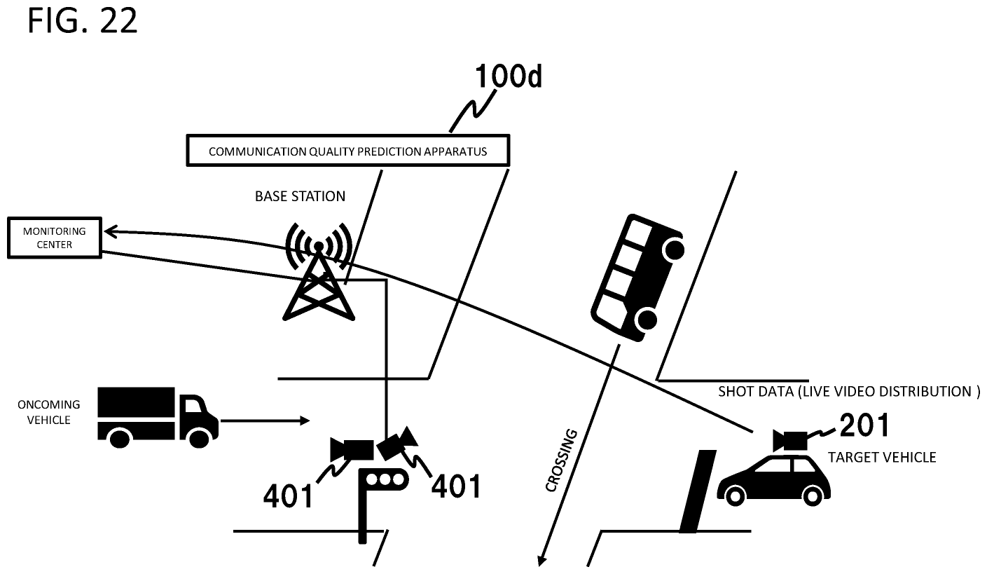

In the present example embodiment, a number of second cameras providing the communication quality prediction apparatus 100d with a video is not limited to one. For example, as shown in FIG. 22, a plurality of second cameras 401 may be placed. In the example as shown in FIG. 22, a plurality of second cameras 401 are placed. By this, it become possible to promptly grasp not only a large vehicle entering an intersection from a crossing direction but also an oncoming vehicle and to predict future communication throughput by taking account of the influence thereof.

As described above, according to the embodiment using a video from the second camera 401, it becomes possible to increase prediction accuracy of future communication throughput. Note, in description of the examples as shown in FIG. 21 and FIG. 22, a communication quality prediction apparatus 100d is placed at a base station side, a communication quality prediction apparatus 100d may be placed at a monitoring station side. A placement and a configuration of each apparatus of that case is equivalent to those as shown in FIG. 5. Furthermore, a communication quality prediction apparatus 100d may be mounted on a target vehicle. A placement and a configuration of each apparatus of that case is equivalent to those as shown in FIG. 4.

Furthermore, in the example embodiment as described above, a communication quality prediction apparatus 100d predicts future communication quality using both a video of a camera 201 and a video of a second camera 401. However, a configuration in which future communication quality is predicted using only a video of a second camera 401 may also be employed. For example, as shown in FIG. 21 and FIG. 22, in a case where an overhead view can be acquired from a second camera 401, it is also possible to omit inputting shot data of a camera 201 to a communication quality prediction apparatus 100d.

### Sixth Example Embodiment

The present invention can be applied to a use for monitoring or the like using a live video from a camera installed in a construction site or a factory in addition to a live video transmission of a video from a camera 201 mounted on a vehicle (target vehicle).

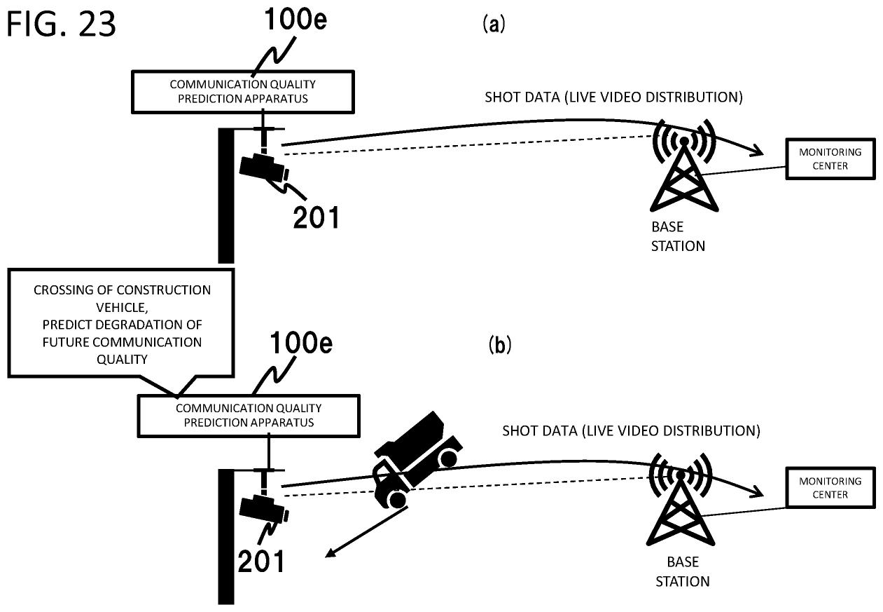

FIG. 23 is a diagram illustrating an operation of a shot data distribution system according to a sixth example embodiment of the present invention. In FIG. 23, a camera 201 is a camera installed in a construction site or a factory. As shown in an upper figure (a) of FIG. 23, a line-of-sight (LOS) communication as indicated by a broken line of FIG. 23 is usually secured between a video transmission apparatus (not shown) to which a camera 201 is connected and a base station. In this case, a communication quality prediction apparatus 100e determines that an event which affects future communication throughput is not occurring, predicts future communication throughput from past communication throughput, and notifies a video transmission apparatus (not shown) of it. In this case, the video transmission apparatus (not shown) encodes a video with a bit rate determined based on communication throughput predicted from past communication throughput and transmit it to a monitoring center.

Meanwhile, as shown in a lower figure (b) of FIG. 23, crossing of a construction vehicle may occur and may result in a non-line-of-sight (NLOS) communication as indicated by a broken line of (b) of FIG. 23. In this case, a construction vehicle is shot in shot data of a camera 201. The communication quality prediction apparatus 100e determines that an event which affects future communication throughput is occurring, predicts future communication throughput by taking account of influence of the construction vehicle, and notifies a video transmission apparatus (not shown) of it. In this case, the video transmission apparatus (not shown) encodes a video with a bit rate determined based on the communication throughput in which influence of crossing of the construction vehicle is estimated and transmits it to the monitoring center. Accordingly, it becomes possible to continue stable distribution of a live video under a condition where the communication throughput is rapidly decreased due to crossing of the construction vehicle.

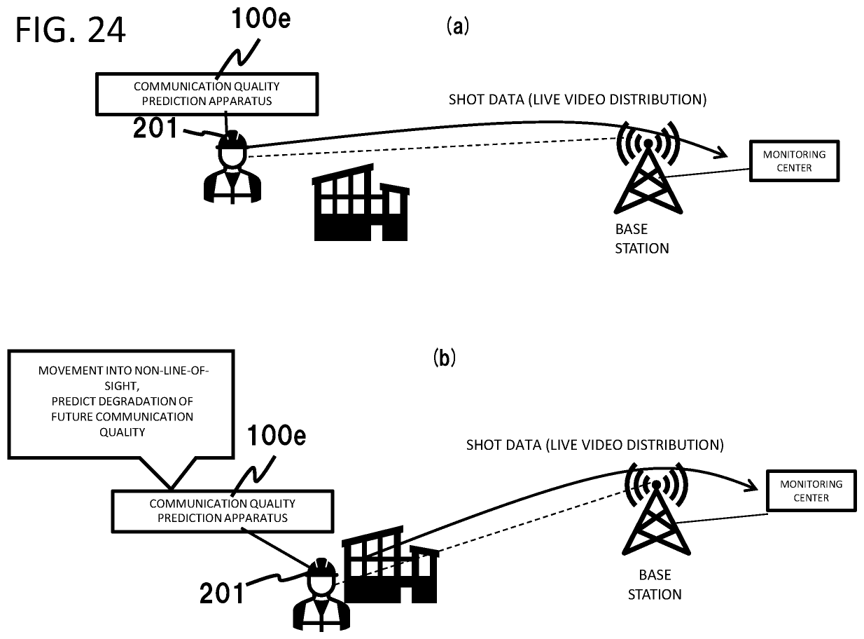

Furthermore, a camera 201 may not be a fixed camera but may be a wearable camera which is attached to a helmet or a working wear of a worker. In FIG. 24, a camera 201 is a camera attached to a helmet of a worker. As shown in an upper figure (a), a line-of-sight (LOS) communication as indicated by a broken line of (a) of FIG. 24 is usually secured between a video transmission apparatus (not shown) to which a camera 201 is connected and a base station. In this case, a communication quality prediction apparatus 100e determines that an event which affects future communication throughput is not occurring, predicts future communication throughput from past communication throughput, and notifies a video transmission apparatus (not shown) of it. In this case, the video transmission apparatus (not shown) encodes a video with a bit rate determined based on communication throughput predicted from past communication throughput and transmits it to a monitoring center.

Meanwhile, as shown in a lower figure (b) of FIG. 24, movement of a worker into a building may occur and may result in a non-line-of-sight (NLOS) communication as indicated by a broken line of (b) of FIG. 24. In this case, it is possible to grasp that a worker has moved into a building from shot data of a camera 201. The communication quality prediction apparatus 100e determines that an event which affects future communication throughput is occurring from such video, predicts future communication throughput by taking account of influence of movement of a worker, and notifies a video transmission apparatus (not shown) of it. In this case, the video transmission apparatus (not shown) encodes a video with a bit rate determined based on the communication throughput in which influence of movement of a worker into a building is estimated and transmits it to the monitoring center. Accordingly, it becomes possible to continue stable distribution of a live video under a condition where a worker has moved into a building and the communication throughput is rapidly decreased.

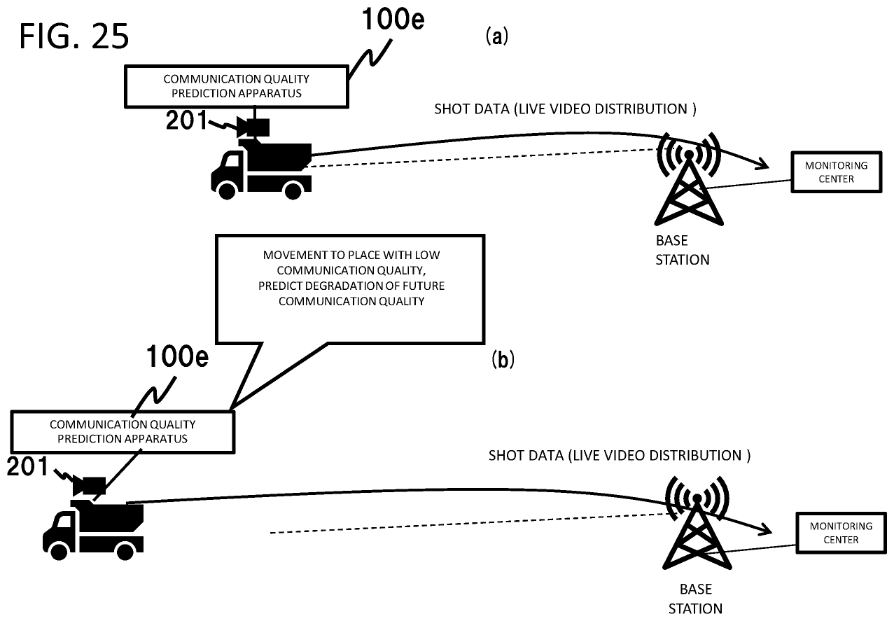

Furthermore, a camera 201 may be a camera mounted on a construction vehicle or the like. As shown in an upper figure (a) of FIG. 25, a line-of-sight (LOS) communication as indicated by a broken line of (a) of FIG. 25 is usually secured between a video transmission apparatus (not shown) to which a camera 201 is connected and a base station. In this case, a communication quality prediction apparatus 100e determines that an event which affects future communication throughput is not occurring, predicts future communication throughput from past communication throughput, and notifies a video transmission apparatus (not shown) of it. In this case, the video transmission apparatus (not shown) encodes a video with a bit rate determined based on communication throughput predicted from past communication throughput and transmits it to a monitoring center.

Meanwhile, as shown in a lower figure (b) of FIG. 25, when a construction vehicle on which the video transmission apparatus (not shown) is mounted moves away from the base station, communication quality will degrade. In this case, it is possible to grasp that a construction vehicle is moving in a direction away from the base station from shot data of a camera 201. The communication quality prediction apparatus 100e determines that an event which affects future communication throughput is occurring from such video, predicts future communication throughput by taking account of influence of movement of a construction vehicle, and notifies a video transmission apparatus (not shown) of it. In this case, the video transmission apparatus (not shown) encodes a video with a bit rate determined based on the communication throughput in which influence of movement of a construction vehicle is estimated and transmits it to the monitoring center. Accordingly, it becomes possible stable distribution of a live video under a condition where a construction vehicle actually moves away from a base station and the communication throughput is decreased.

Furthermore, in any case as shown in FIG. 23 to FIG. 25, it is expected that communication throughput is recovered when crossing of a construction vehicle is finished, a worker moves out of a building, or a construction vehicle approaches a base station. In these cases, as in the same way as the first to fifth example embodiments, a communication quality prediction apparatus 100e can predict increase in future throughput by detecting these events based on shot data of a camera 201 and notifies a video transmission apparatus (not shown) of it. Accordingly, it is possible to promptly raise a bit rate which has once decreased and improve image quality of a live video.

The exemplary embodiments of the present invention have been described as above, however, the present invention is not limited thereto. Further modifications, substitutions, or adjustments can be made without departing from the basic technical concept of the present invention. For example, the configurations of the system and the elements and the placement of the apparatuses or the like illustrated in the individual drawings are merely used as examples to facilitate the understanding of the present invention. Thus, the present invention is not limited to the configurations illustrated in the drawings.

For example, in each example embodiment described above, although it is described by assuming that a video transmission apparatus 200 determines a bit rate for encoding a video according to communication quality, it is also possible to employ a configuration in which a parameter related to quality of shot data other than a bit rate is adjusted. Such parameters include resolution (size), gradation, a frame rate, a color gamut, a dynamic range of luminance or the like.

Furthermore, in each example embodiment, a camera 210 is described as a visible-light camera which shots a view ahead of the camera but it is not limited thereto. For example, a 360-degree camera of which a shooting range is not limited, a camera which can acquire depth other than a video (depth camera), an infra-red camera may also be employed. Furthermore, LiDAR (Laser Detection and Ranging) may also be employed.

Furthermore, in each example embodiments as described above, it is described that a communication quality prediction apparatus predicts communication throughput as communication quality of a network used for transmission of first sensor data, it is also possible to use information other than communication throughput as communication quality. As communication quality, for example, information regarding signal quality, such as RSRP (Reference Signal Received Power), RSRQ (Reference Signal Received Quality), RSSI (Received Signal Strength Indicator), and SINR (Signal-to-Interference-plus-Noise Ratio), can be used. Furthermore, it is possible to employ a configuration in which a communication quality prediction apparatus predicts a parameter controlled according to signal quality, such as MCS (Modulation and Coding Scheme), other than information regarding signal quality.

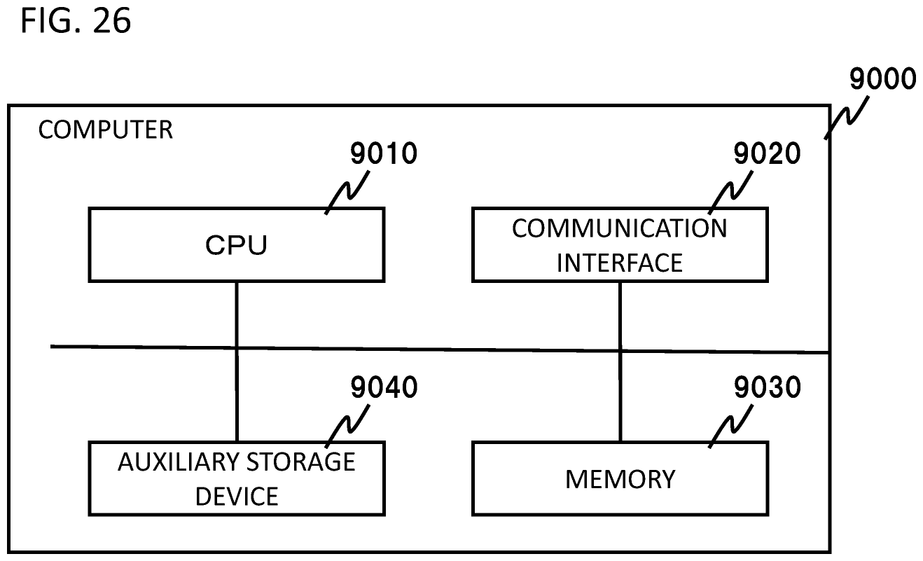

In addition, the procedures described in the above first to sixth example embodiments can be realized by a program causing a computer (9000 in FIG. 26) functioning as a communication quality prediction apparatus 100 to 100e to realize functions of the communication quality prediction apparatus 100 to 100e. For example, this computer is configured to include a CPU (Central Processing Unit) 9010, a communication interface 9020, a memory 9030, and an auxiliary storage device 9040 in FIG. 26. That is, the CPU 9010 in FIG. 26 executes a data acquisition program and a communication quality prediction program and performs processing for updating various calculation parameters stored in the auxiliary interface or the like.

That is, the individual parts (processing means, functions) of the communication quality prediction apparatus 100 to 100e in each of example embodiment as described above can each be realized by a computer program that causes a processor mounted on the corresponding apparatus to execute the corresponding processing described above by using corresponding hardware.

Finally, suitable modes of the present invention will be summarized.

### Mode 1

(See the data distribution system according to the above first aspect)

### Mode 2

It is possible to employ a configuration in which the first prediction means of the data distribution system as described above can acquire second sensor data acquired by a second apparatus which is different from a first apparatus which acquires the first sensor data in place of the first sensor data, and
wherein the first prediction means predict communication quality of the network used for transmission of the first sensor data based on the second sensor data.

### Mode 3

It is possible to employ a configuration in which the first prediction means of the data distribution system as described above can further acquire second sensor data acquired by a second apparatus which is different from a first apparatus which acquires the first sensor data, and
wherein the first prediction means predict communication quality of the network used for transmission of the first sensor data based on the first sensor data and the second sensor data.

### Mode 4

It is possible to employ a configuration in which the prediction means of the data distribution system as described above further predict the communication quality using a history of communication quality of the network.

### Mode 5

It is possible to employ a configuration in which the data distribution system as described above, further comprising:
second prediction means for predicting communication quality using a history of communication quality of the network; and
wherein the determination means determine a parameter related to transmission quality of the first sensor data according to the communication quality predicted by the second prediction means in response to change of communication quality predicted by the first prediction means.

### Mode 6

It is possible to employ a configuration in which the determination means of the data distribution system as described above determine a parameter related to transmission quality of the first sensor data based on the lower communication quality of a prediction result of the first prediction means and a prediction result of the second prediction means.

### Mode 7

It is possible to employ a configuration in which the prediction means of the data distribution system as described above predict communication quality using position information of the first apparatus.

### Mode 8

It is possible to employ a configuration to use a video bit rate as a parameter related to quality of the first sensor data in the data distribution system as described above.

### Mode 9

It is possible to employ a configuration in which the data distribution system as described above increases or decreases a video bit rate by increasing or decreasing at least one of resolution of a video, a frame rate, a target bit rate, QP (Quantization Parameter), CRF (Constant Rate Factor), and an encoding method (CODEC type) according to a predetermined setting.

### Mode 10

It is possible to employ a configuration in which the first apparatus of the data distribution system as described above is a camera mounted on a movable body, and
wherein the first prediction means predict communication quality of the network based on an event appeared in the first sensor data with movement of the movable body.

### Mode 11

It is possible to employ a configuration in which the second apparatus of the data distribution system as described above is a fixed camera which can shot the movable body.

### Mode 12

It is possible to employ a configuration in which the prediction means of the data distribution system as described above is placed in a predetermined reception apparatus or a relay server on the network.

### Mode 13

(See the communication quality prediction apparatus according to the above second aspect)

### Mode 14

(See the data transmission apparatus according to the above third aspect)

### Mode 15

(See the data transmission method according to the above fourth aspect)

### Mode 16

(See the program according to the above fifth aspect)

Note, the above thirteenth to sixteenth modes can be expanded to the second to twelve modes in the same way as the first mode is expanded.

The disclosure of each of the above PTLs is incorporated herein by reference thereto and may be used as the basis or a part of the present invention, as needed. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be construed to have been concretely disclosed. In addition, as needed and based on the gist of the present invention, the individual disclosed matters in the above literatures, as a part of the disclosure of the present invention, and partial or entire use of the individual disclosed matters in the above literatures that have been referred to in combination with what is disclosed in the present application, should be deemed to be included in what is disclosed in the present application.

### REFERENCE SIGNS LIST

10 data distribution system
10a, 10c, 10e data transmission apparatus
10b, 10f communication quality prediction apparatus
11 first prediction means
12 determination means
13 encoding means
14 transmission means
80 data reception apparatus
90 network
100, 100a, 100b, 100c, 100d 100e communication quality prediction apparatus
101, 101a, 101b, 101d prediction part
102, 102c, 102d data acquisition part
200 video transmission apparatus
201 camera
202 encoding control part
203 encoding part
300 video reception apparatus
301 communication quality measurement part
302 decoding part
303 reproduction part
1011 first predictor
1012 second predictor
1013, 1013b unification part
1021 video acquisition part
1022 communication quality acquisition part
9000 computer
9010 CPU
9020 communication interface
9030 memory
9040 auxiliary storage device

What is claimed is:

1. A data distribution system, comprising:
at least a processor; and
a memory in circuit communication with the processor,
wherein the processor is configured to execute program instructions stored in the memory to implement:
a first prediction part for predicting communication quality of a network used for transmission of first sensor data based on the first sensor data;
a determination part for determining a parameter related to transmission quality of the first sensor data according to the communication quality predicted by the first prediction part;
an encoding part for encoding the first sensor data using the parameter related to the transmission quality of the first sensor data; and
a transmission part for transmitting the encoded first sensor data via the network.

2. The data distribution system according to claim 1,
wherein the first prediction part can acquire second sensor data acquired by a second apparatus which is different from a first apparatus which acquires the first sensor data in place of the first sensor data, and
wherein the first prediction part predicts communication quality of the network used for transmission of the first sensor data based on the second sensor data.

3. The data distribution system according to claim 1,
wherein the first prediction part can further acquire second sensor data acquired by a second apparatus which is different from a first apparatus which acquires the first sensor data, and
wherein the first prediction part predicts communication quality of the network used for transmission of the first sensor data based on the first sensor data and the second sensor data.

4. The data distribution system according to claim 1,
wherein the first prediction part further predicts the communication quality of the network using a history of communication quality of the network.

5. The data distribution system according to claim 1, further comprising: wherein the processor is configured to execute the program instructions to implement:
a second prediction part for predicting communication quality of the network using a history of communication quality of the network; and
wherein the determination part determines a parameter related to transmission quality of the first sensor data according to the communication quality predicted by the second prediction part in response to change of communication quality predicted by the first prediction part.

6. The data distribution system according to claim 5,
wherein the determination part determines a parameter related to transmission quality of the first sensor data based on a lower communication quality out of a prediction result of the first prediction part and a prediction result of the second prediction part.

7. The data distribution system according to claim 1,
wherein the parameter related to transmission quality of the first sensor data is a bit rate.

8. The data distribution system according to claim 2,
wherein the first apparatus is a camera mounted on a movable body, and
wherein the first prediction part predicts communication quality of the network based on an event appeared in the first sensor data due to movement of the movable body.

9. A communication quality prediction apparatus, comprising:
at least a processor; and
a memory in circuit communication with the processor,
wherein the processor is configured to execute program instructions stored in the memory to implement:
a first prediction part for predicting communication quality of a network used for transmission of first sensor data based on the first sensor data; and
a transmission part for transmitting the predicted communication quality of the network used for transmission of the first sensor data to an apparatus of a transmission source of the first sensor data;
wherein the communication quality prediction apparatus causes the apparatus of the transmission source of the first sensor data to execute to encode the first sensor data according to the predicted communication quality of the network used for transmission of the first sensor data and to transmit the encoded first sensor data.

10. The communication quality prediction apparatus according to claim 9,
wherein the first prediction part can acquire second sensor data acquired by a second apparatus which is different from a first apparatus which acquires the first sensor data in place of the first sensor data, and
wherein the first prediction part predicts communication quality of the network used for transmission of the first sensor data based on the second sensor data.

11. The communication quality prediction apparatus according to claim 9,
wherein the first prediction part can further acquire second sensor data acquired by a second apparatus which is different from a first apparatus which acquires the first sensor data, and
wherein the first prediction part predicts communication quality of the network used for transmission of the first sensor data based on the first sensor data and the second sensor data.

12. The communication quality prediction apparatus according to claim 9,
wherein the first prediction part further predicts the communication quality of the network using a history of communication quality of the network.

13. The communication quality prediction apparatus according to claim 9, wherein the processor is configured to execute the program instructions to implement:
a second prediction part for predicting communication quality of the network using a history of communication quality of the network; and
wherein the communication quality prediction apparatus determines a parameter related to transmission quality of the first sensor data according to the communication quality predicted by the second prediction part in response to change of communication quality predicted by the first prediction part.

14. A data transmission apparatus, which can execute to receive predicted communication quality of a network used for transmission of first sensor data from a communication quality prediction apparatus comprising:
at least a processor; and
a memory in circuit communication with the processor,
wherein the processor is configured to execute program instructions stored in the memory to implement:
a first prediction part for predicting the communication quality of the network used for transmission of first sensor data based on the first sensor data; and
a transmission part for transmitting the predicted communication quality of the network used for transmission of the first sensor data to an apparatus of a transmission source of the first sensor data; and
wherein the data transmission apparatus can execute to:
encode the first sensor data according to the communication quality, and
transmit the encoded first sensor data.

15-17. (canceled)

18. The communication quality prediction apparatus according to claim 13,
wherein the determination part determines a parameter related to transmission quality of the first sensor data based on a lower communication quality out of a prediction result of the first prediction part and a prediction result of the second prediction part.

19. The data transmission apparatus according to claim 14,
wherein the first prediction part can acquire second sensor data acquired by a second apparatus which is different from a first apparatus which acquires the first sensor data in place of the first sensor data, and
wherein the first prediction part predicts communication quality of the network used for transmission of the first sensor data based on the second sensor data.

20. The data transmission apparatus according to claim 14,
wherein the first prediction part can further acquire second sensor data acquired by a second apparatus which is different from a first apparatus which acquires the first sensor data, and
wherein the first prediction part predicts communication quality of the network used for transmission of the first sensor data based on the first sensor data and the second sensor data.

21. The data transmission apparatus according to claim 14,
wherein the first prediction part further predicts the communication quality of the network using a history of communication quality of the network.

22. The data transmission apparatus according to claim 14, wherein the processor is configured to execute the program instructions to implement:
a second prediction part for predicting communication quality of the network using a history of communication quality of the network; and
wherein the determination part determines a parameter related to transmission quality of the first sensor data according to the communication quality predicted by the second prediction part in response to change of communication quality predicted by the first prediction part.

23. The data transmission apparatus according to claim 22,
wherein the determination part determines a parameter related to transmission quality of the first sensor data based on a lower communication quality out of a prediction result of the first prediction part and a prediction result of the second prediction part.
